(19) United States
(12) Patent Application Publication
(10) Pub. No.: US 2002/0022989 A1
(43) Pub. Date: Feb. 21, 2002

(54) Advertisement information providing system, advertisement information providing method, and computer-readable recording medium recorded with advertisement information providing program

(76) Inventors: Takahiro Endo, Tokyo (JP); Tadamasa Nagata, Tokyo (JP)

Correspondence Address: STAAS & HALSEY LLP, 700 11TH STREET, NW, SUITE 500, WASHINGTON, DC, 20001, US

(21) Appl. No.: 09/741,907

(22) Filed: Dec. 22, 2000

(30) Foreign Application Priority Data
Aug. 17, 2000 (JP) 2000-247597

(51) Int. Cl. G06F 17/60

(52) U.S. Cl. 705/14; 705/1

(57) ABSTRACT

An advertisement information providing system, an advertisement information providing method, and a computer-readable recording medium recorded with an advertisement information providing program improves a publicizing effect due to advertisement information. This is achieved by requiring input of preference trends of an addressee as a compensation for providing at no cost a card sending service for sending cards attached with an optional message, and then attaching to the card, advertisement information selected based on the preference trends.

### BACKGROUND OF THE INVENTION

(1) Field of the Invention

The present invention relates to technology for improving a publicizing effect due to advertisement information provided by businesses and the like to the consumer.

(2) Related Art of the Invention

Heretofore, there is known a publicizing format for providing advertisement information such as DM (direct mail) to individual consumers, using mail so that businesses and the like can publicize their products and services. Advertisement information for consumers is provided based on customer information held by a business, or based on information held by a specialist.

However, with this publicizing format, advertisement information is only provided to consumers registered in the information held by the business, and hence this cannot be directed to consumers of the general public. Furthermore, it is known that advertisement information provided to consumers is not always limited to products and services for which the consumer has an interest, and it is also empirically known that the probability of this being discarded without being opened is high. Therefore, with the conventional publicizing format using mail, it is difficult to acquire new customers, and also the opening rate and retention rate is low, so that it is unlikely to expect an improvement in the publicizing effect.

Therefore, the present invention takes into consideration the heretofore problems as mentioned above, with the object of providing advertisement information providing technology where the publicizing effect is improved by providing advertisement information for businesses and the like which has appeal to users and card addressees, in return for providing the user with a service for sending a post card or an electronic greeting card at no cost.

### SUMMARY OF THE INVENTION

Therefore, with the advertisement information providing technology according to the present invention, as a compensation for providing a service for sending a card attached with an optional message to a specified addressee, an input of preference trends of the addressee is required. Then, when the preference trends of the addressee are input, advertisement information suitable for those preference trends is selected, and the selected advertisement information is added to the card.

With such a construction, advertisement information related to the product or service selected based on the preference trend of the addressee, is attached to the card to be sent to the addressee, and hence the card retention rate is improved. Moreover, the result in that the card sending service is provided to consumers of the general public, means that cards are also sent to consumers of the general public, so that for the advertisement provider, the possibility of acquiring new customers is increased. Consequently, the publicizing effect due to the advertisement information can be improved.

Here the input of preference trends of the card sending client may be required, and advertisement information suitable for the preference trends of the sending client may be presented to the sending client. By so doing, the user of the card sending service sees the advertisement information related to the product or service which is selected based on their own preference trends, at the time of a card sending request.

Moreover, one piece of advertisement information selected by the sending client from amongst a plurality of advertisement information suitable for the preference trends of the addressee may be added. In this case, it is desirable that the advertisement information already provided to the addressee is excluded based on the card sending history of the sending client.

With such a construction, the advertisement information selected by the sending client who knows the situation of the addressee very well, is added to the card to be sent to the addressee, so that the probability that the addressee will show an interest in the advertisement information is increased. Moreover, if the already provided advertisement information is excluded based on the card sending history, then the supply of duplicate advertisement information to the same addressee is prevented, thus avoiding wastefulness.

Furthermore, the additional information to be added to the card may be changed based on the utilization frequency of the card sending service by the sending client. Moreover, by also sending the card to which is attached advertisement information and additional information, to the sending client, and simultaneously inputting additional information added to the card of the addressee and the sending client, advertisement information which is specified by the additional information may be output.

With such a construction, if for example the additional information is a coupon (discount coupon) for the product or service, then the discount rate may be changed in accordance with the utilization frequency of the card sending service, so that the utilization frequency of the card sending service is increased. Furthermore, if by simultaneously inputting additional information which has been added to the card sent to the addressee and the sending client, advertisement information which is specified by the additional information is output, then a customer accumulation effect due to the advertisement information is improved.

In addition, advertisement identification information for identifying non-visual advertisement information may be added to the card, and the non-visual advertisement information then output based on the advertisement identification information. In this way, even if there is advertisement information such as music or images which cannot be shown with a card, the addressee can use this, and advertisement information which cannot be transmitted in the current publicizing format, can also be provided.

Other objects and aspects of the present invention will become apparent from the following description of embodiments, given in conjunction with the appended drawings.

### BRIEF EXPLANATION OF THE DRAWINGS

FIG. 1 is an overall configuration of an advertisement information providing system according to the present invention.

FIG. 2 is a detailed configuration of a Web server of FIG. 1.

FIG. 3 is a flowchart showing member registration processing.

FIG. 4 is a schematic diagram for explaining a member registration screen.

FIG. 5 is a schematic diagram for explaining a member information table.

FIG. 6 is a schematic diagram for explaining a sex table.

FIG. 7 is a schematic diagram for explaining an information providing table.

FIG. 8 is a schematic diagram for explaining a target occupation table.

FIG. 9 is a schematic diagram for explaining a target field table.

FIG. 10 is a schematic diagram for explaining a region table.

FIG. 11 is a flowchart showing advertisement provider registration processing.

FIG. 12 is a schematic diagram for explaining an advertisement provider registration screen.

FIG. 13 is a schematic diagram for explaining an advertisement provider information table.

FIG. 14 is a flowchart showing advertisement information registration processing.

FIG. 15 is a schematic diagram for explaining an advertisement information registration screen.

FIG. 16 is a schematic diagram for explaining an advertisement information table.

FIG. 17 is a schematic diagram for explaining a generation table.

FIG. 18 is a flowchart showing card sending processing.

FIG. 19 is a flowchart showing card sending processing.

FIG. 20 is a flowchart showing card sending processing.

FIG. 21 is a schematic diagram for explaining an addressee attribute input screen.

FIG. 22 is a schematic diagram for explaining a card selection screen.

FIG. 23 is a schematic diagram for explaining a card confirmation screen.

FIG. 24 is a schematic diagram for explaining an addressee information input screen.

FIG. 25 is a schematic diagram for explaining an input information confirmation screen (first example).

FIG. 26 is a schematic diagram for explaining an input information confirmation screen (second example).

FIG. 27 is a schematic diagram for explaining an input information confirmation screen (third example).

FIG. 28 is a schematic diagram for explaining an input information confirmation screen (fourth example).

FIG. 29 is a schematic diagram for explaining an input information confirmation screen (fifth example).

FIG. 30 is a schematic diagram for explaining an addressee attribute input screen in a mobile communication terminal.

FIG. 31 is a schematic diagram for explaining an addressee information input screen in a mobile communication terminal.

FIG. 32 is a schematic diagram for explaining an input information confirmation screen in a mobile communication terminal.

FIG. 33 is a flowchart showing discount plan defining processing.

FIG. 34 is a flowchart showing coupon issuing processing.

FIG. 35 is a flowchart showing advertisement information retrieve processing.

FIG. 36 is a schematic diagram of a shop system linked advertisement information table.

### DESCRIPTION OF THE PREFERRED EMBODIMENT

At first is a description of generationneral overview of an advertisement information providing system according to the present invention.

With the advertisement information providing system, in order to improve a publicizing effect of advertisement information provided from a business or the like to a consumer, the following features are included.

A card sending service is provided to consumers of the general public (referred to hereunder as “users”), on the provision of member registration, for sending at zero cost, a post card or an electronic greeting card to which an optional message is attached. The card sending service is provided in a Web site on the Internet, and the cost thereof is paid for by the business providing the advertisement information. As compensation for receiving the card sending service, the user is requested to input the attributes (for example sex, generation, occupation, hobbies etc.) of the addressee, and advertisement information selected based on these attributes is attached to the card. Therefore, advertisement information related to the products and services for which the addressee is thought to have an interest, is attached to the card to be sent, thus enabling an improvement in the card retention rate. Furthermore, since the card sending service is provided to consumers of the general public, the card addressee is also the general public, and hence the possibility of acquiring new customers can also be increased.

On the other hand, the user, at the time of performing member registration, is requested to input personal information such as name, date of birth, address, e-mail address, occupation, hobbies, and interests. Then, when the card sending service is used, advertisement information selected based on the personal information is displayed on the browser of the user. Therefore, when the user uses the card sending service, they see advertisement information related to products and services having a high probability of interest to them.

Consequently, advertisement information considered to be of interest to both the user and the addressee is provided. Furthermore, since the card retention rate is also improved, the publicizing effect for the advertisement information can be improved.

Next, embodiments of the advertisement information providing system are explained in detail while referring to the appended drawings.

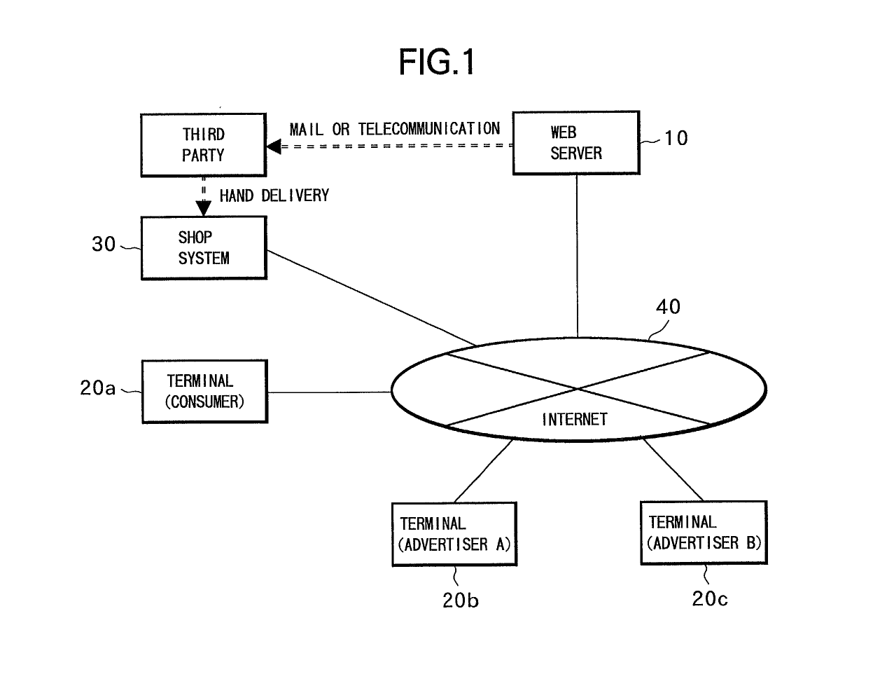

FIG. 1 shows an overall configuration of an advertisement information providing system.

The advertisement providing system comprises a Web server 10, at least one terminal 20 (20a˜20c) and a shop system 30. The Web server 10, the terminal 20 and the shop system 30 are connected to each other via the Internet 40.

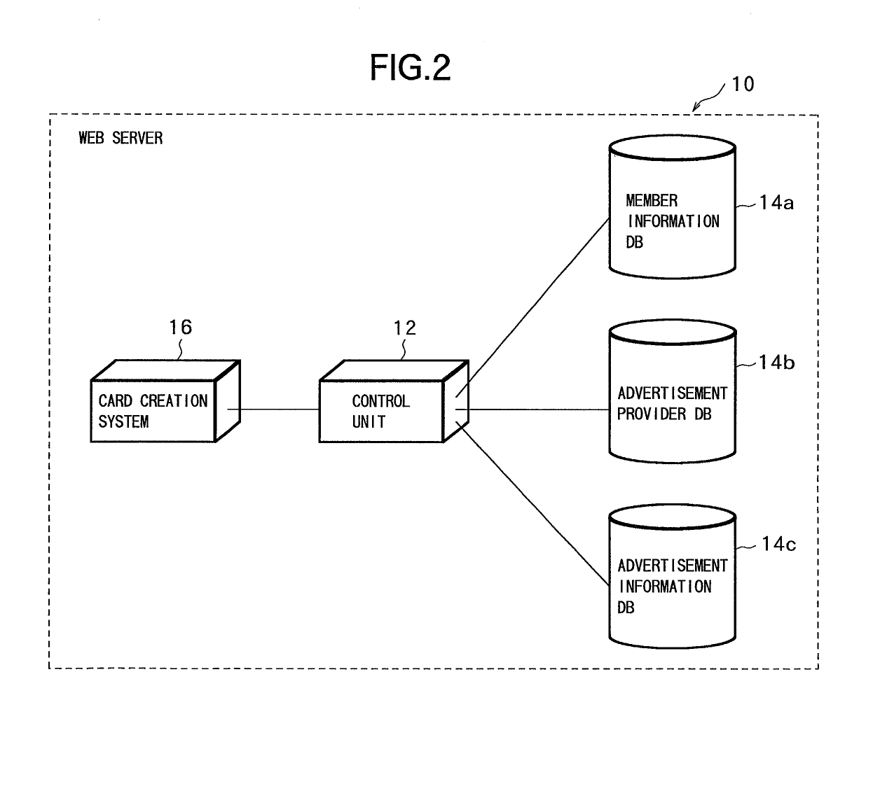

The Web server 10, as shown in FIG. 2, includes a control unit 12 comprising a computer provided with at least a CPU and a memory, a member information DB (data base) 14a, an advertisement provider DB 14b, an advertisement information DB 14c, and a card creation system 16. In the control unit 12, various functions related to the card sending service are realized by software in accordance with a program loaded into the memory. In the member information DB 14a is registered various information related to users of the card sending service. In the advertisement provider DB 14b is registered various information related to businesses or the like which provide the advertisement information. In the advertisement information DB 14c is registered advertisement information and associated information thereof supplied by the registered businesses or the like registered in the advertisement provider DB 14b. The card creation system 16 comprises printing equipment such as a printer for printing post cards, or a computer for creating electronic greeting cards.

By means of the Web server 10, card sending service providing means, a card sending service providing step, and a card sending service providing function are realized. Moreover, by means of the control unit 12, various devices, steps and functions constituting the present invention are realized.

The terminal 20 comprises a computer having a display section comprising, for example, a CRT (cathode ray tube) or an LCD (liquid crystal display), and an input section comprising for example a keyboard and mouse. Furthermore, in the terminal 20 is installed a browser (access program) for accessing Web sites for providing the card sending service.

The shop system 30, as described later, reads out advertisement identification information such as a bar code attached to the card, and outputs advertisement information registered in the advertisement information DB 14c via the Internet 40. Here, if for example the advertisement information was for the introduction of a new song, the shop system 30 would be installed in a CD shop or the like.

The advertisement information providing system of such a configuration is controlled by various processing as described hereunder.

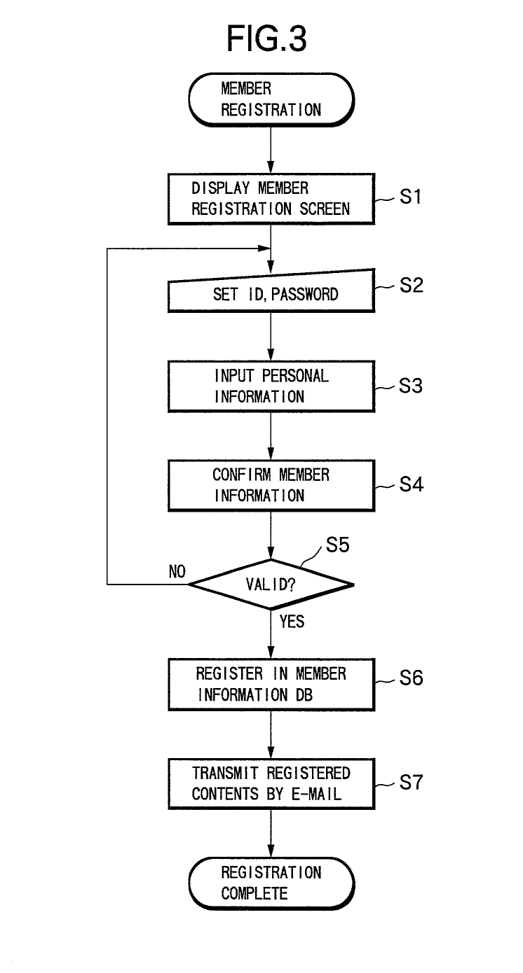

FIG. 3 is a flowchart showing member registration processing. Here “member registration processing” means registration processing which must be performed at first by the consumer who intends to use the card sending service.

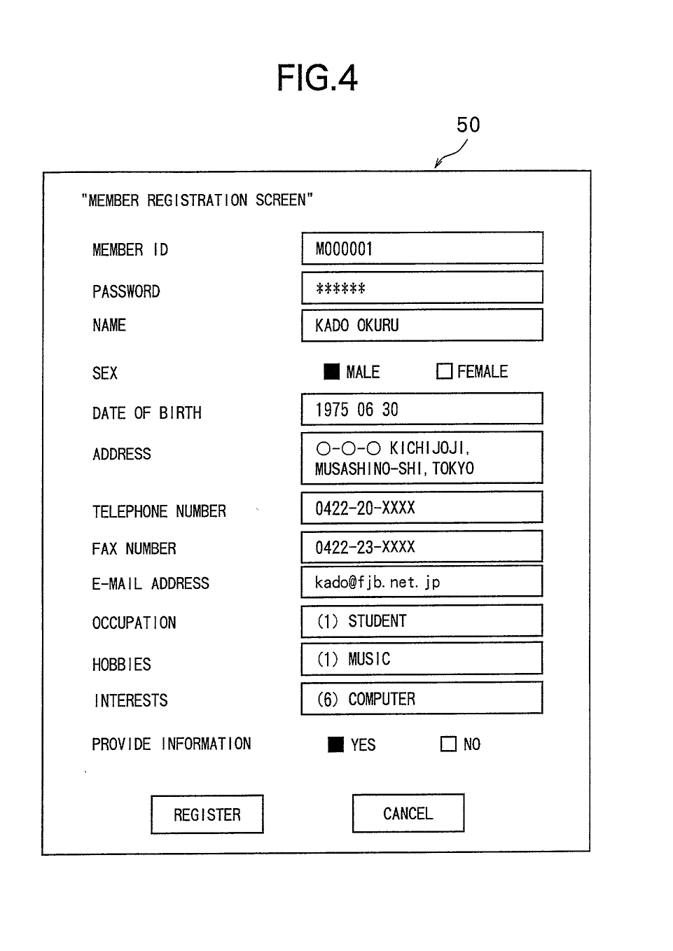

In step 1 (abbreviated to “S1” in the figure, and similarly thereafter), a member registration screen 50 such as shown in FIG. 4 is displayed on the terminal 20a of the consumer. The member registration screen 50 comprises; an input section for inputting member ID, a password and personal information, a “register” button, and a “cancel” button. Here “personal information” means various information which the individual specifies, such as name, sex, date of birth, address, telephone number, fax number, mail address, occupation, hobbies, interests, and whether or not to provide information. Furthermore “whether or not to provide information” means specifying whether or not it is desired to receive advertisement information related to products and services, from a business or the like via electronic mail.

In step 2, the member ID and password are set.

In step 3, the personal information is input. Here “occupation”, “hobbies” and “interests” are selected from amongst a plurality of previously set headings, as being considered the most suitable. By means of the processing of step 3, preference trend input means and second preference trend input means are realized.

In step 4, it is confirmed whether or not the member ID, the password and the personal information (hereunder referred to as member information) have been input correctly.

In step 5, when the “register” button is pressed, it is judged whether or not the member information is valid. Then, if the member information is valid, control proceeds to step 6 (Yes), while if the member information is not valid, control returns to step 2 (No), and re-input of the member information is prompted.

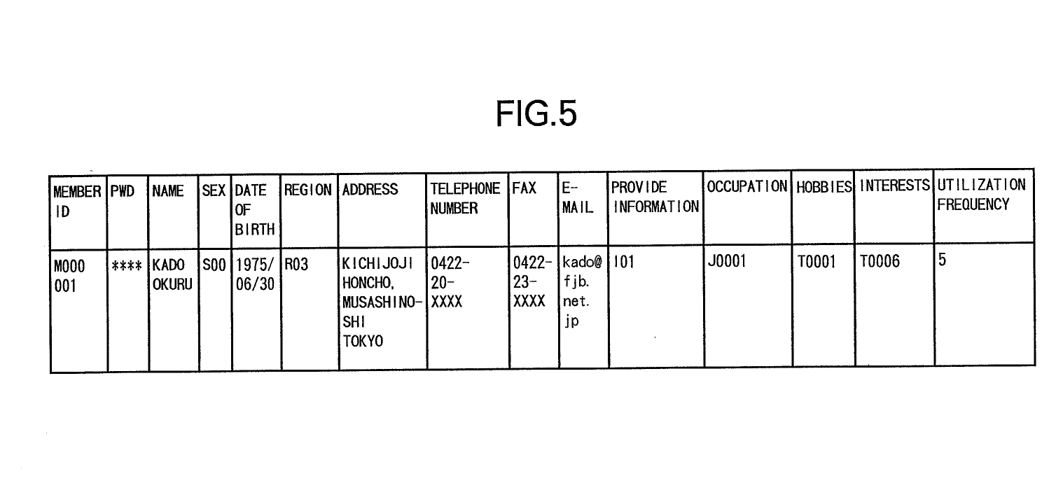

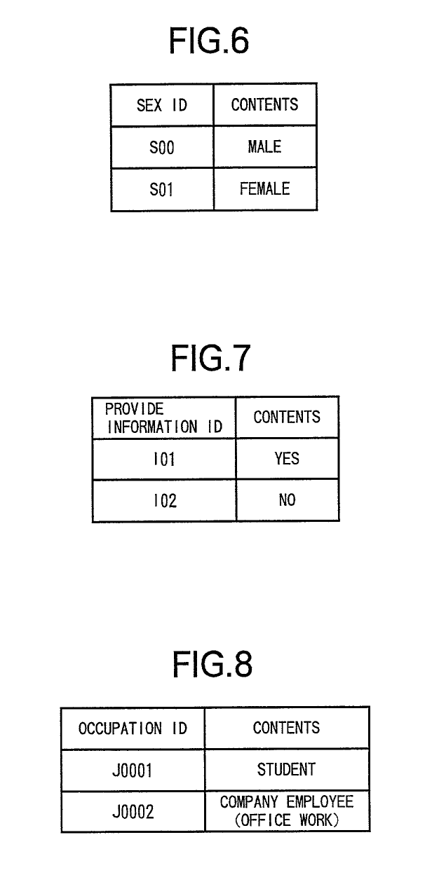

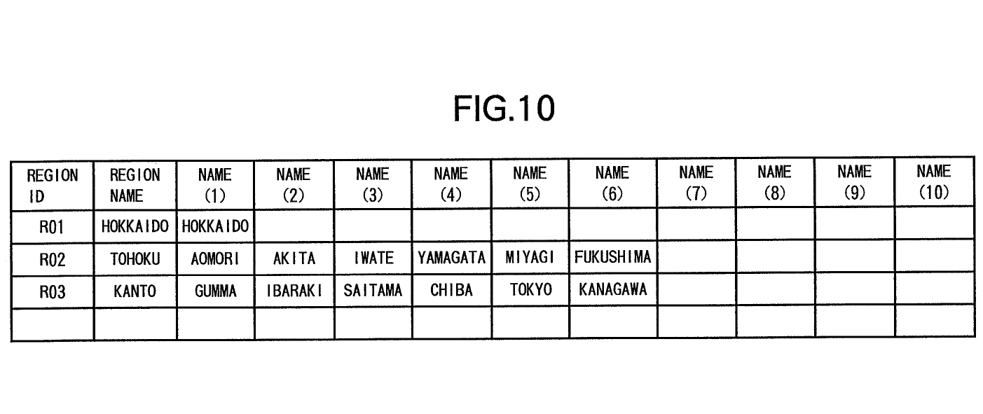

In step 6, the input member information is registered in a member information table (refer to FIG. 5) of the member information DB 14a. Here in the “sex”, “provide information”, “occupation”, “hobbies and interests” sections in the member information table, are registered IDs prescribed by various tables respectively as shown in FIG. 6 through FIG. 9. Furthermore, in the “region” section is registered region IDs corresponding to region names of input addresses, from reference to a region table such as shown in FIG. 10 based on the input addresses. In the “utilization frequency” section serving as utilization frequency counting means, is registered the cumulative number of times that the card sending service has been used. At the time of member registration, a zero is registered as an initial value.

In step 7, in order to notify that member registration has been completed, the registration contents are transmitted by electronic mail.

With the above described processing of step 1 through step 7, the consumer who intends to use the card sending service, inputs the member information from the terminal 20a, and these contents are registered in the member information DB 14a, thereby obtaining authority as a member who can receive the card sending service.

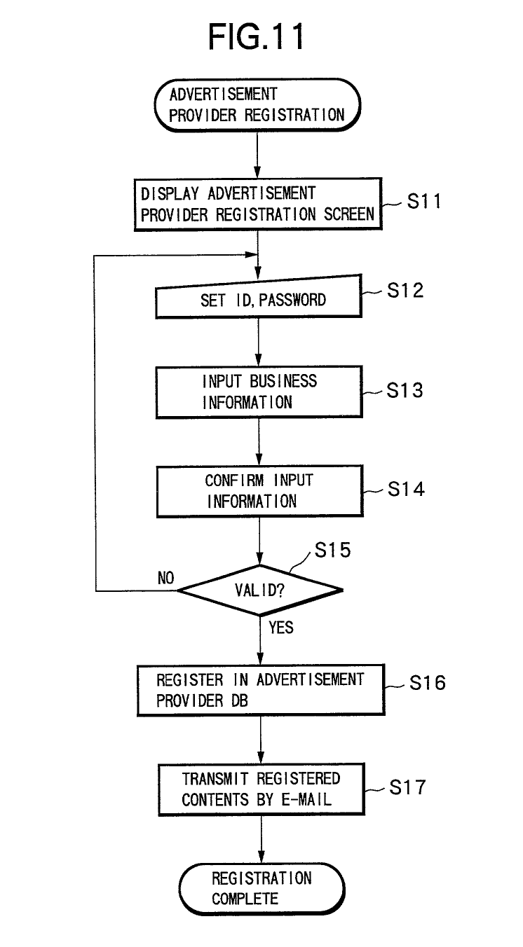

FIG. 11 is a flowchart showing the advertisement provider registration processing. Here “advertisement provider registration processing” means registration processing which must be performed at first by a business or the like which provides advertisement information related to products and services.

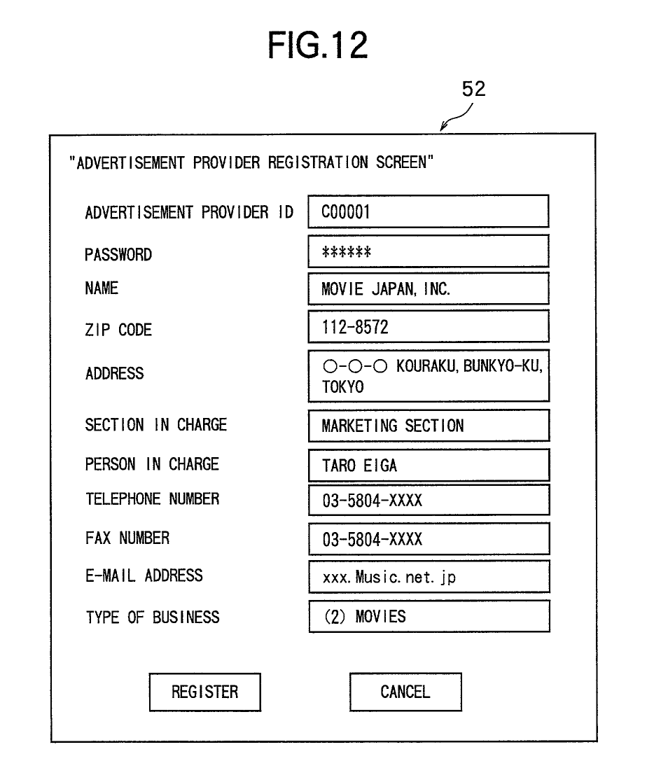

In step 11, an advertisement provider registration screen 52 such as shown in FIG. 12 is displayed on the terminals 20b and 20c of the advertiser. The advertisement provider registration screen 52 comprises; an input section for inputting advertisement provider ID, password, and business specific information, a “register” button, and a “cancel” button. Here “business specific information” means various information which specify a business or the like, such as; name, zip code, address, section in charge, person in charge, telephone number, fax number, e-mail address, and type of business.

In step 12, the advertisement provider ID and password are set.

In step 13, the business specific information is input. Here “type of business”, is selected from amongst a plurality of previously set headings, as being considered most suitable.

In step 14, it is confirmed whether or not the advertisement provider ID, the password and the business specific information (hereunder referred to as business information) have been input correctly.

In step 15, when the “register” button is pressed, it is judged whether or not the business information is valid. Then, if the business information is valid, control proceeds to step 16 (Yes), while if the business information is not valid, control returns to step 12 (No), and re-input of the business information is prompted.

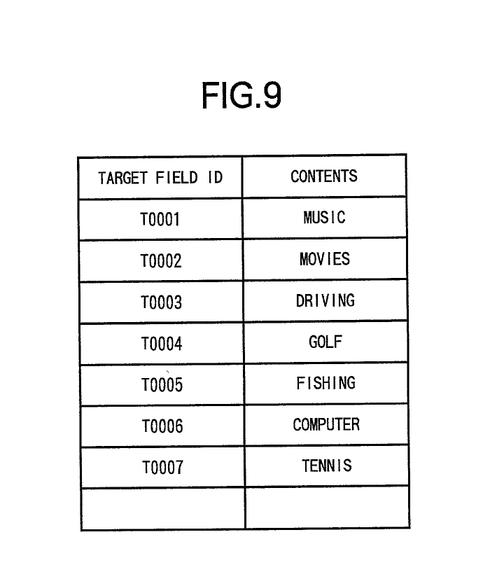

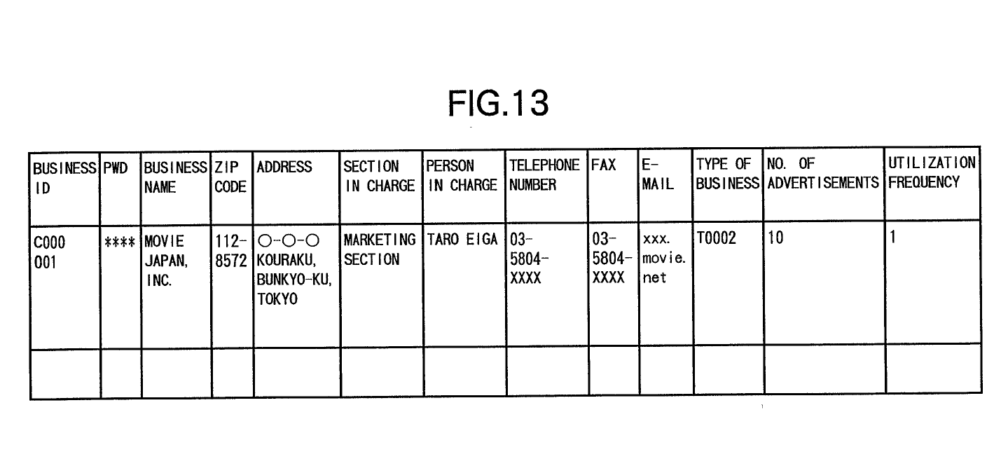

In step 16, the input business information is registered in an advertisement provider information table (refer to FIG. 13) of the advertisement provider DB 14b. Here in the “business type” section in the advertisement provider information table, is registered a target field ID prescribed by a target field table shown in FIG. 9. Furthermore, in the “advertisement number” and the “utilization frequency” sections, are respectively registered the number of pieces of advertisement information provided and the cumulative number of times that the advertisement information has been provided. At the time of advertisement provider registration, a zero is registered as an initial value.

In step 17, in order to notify that advertisement provider registration has been completed, the registration contents are transmitted by electronic mail.

With the above described processing of step 11 through step 17, the business or the like which intends to provide advertisement information related to their products or services, inputs the business information from the terminals 20b and 20c, and these contents are registered in the advertisement provider DB 14b. Then the authority as a business or the like which can provide advertisement information, is obtained via the advertisement information providing system.

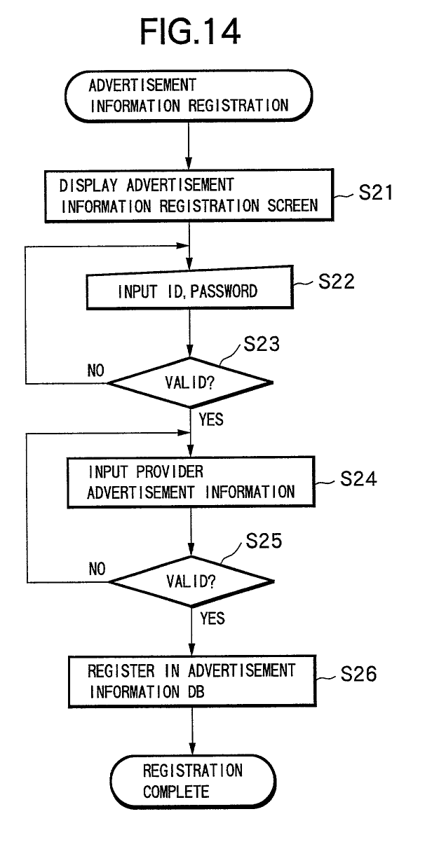

FIG. 14 is a flowchart showing the advertisement information registration processing. Here “advertisement information registration processing” means registration processing for registering advertisement information which a business or the like registered in the advertisement provider DB 14b actually intends to provide.

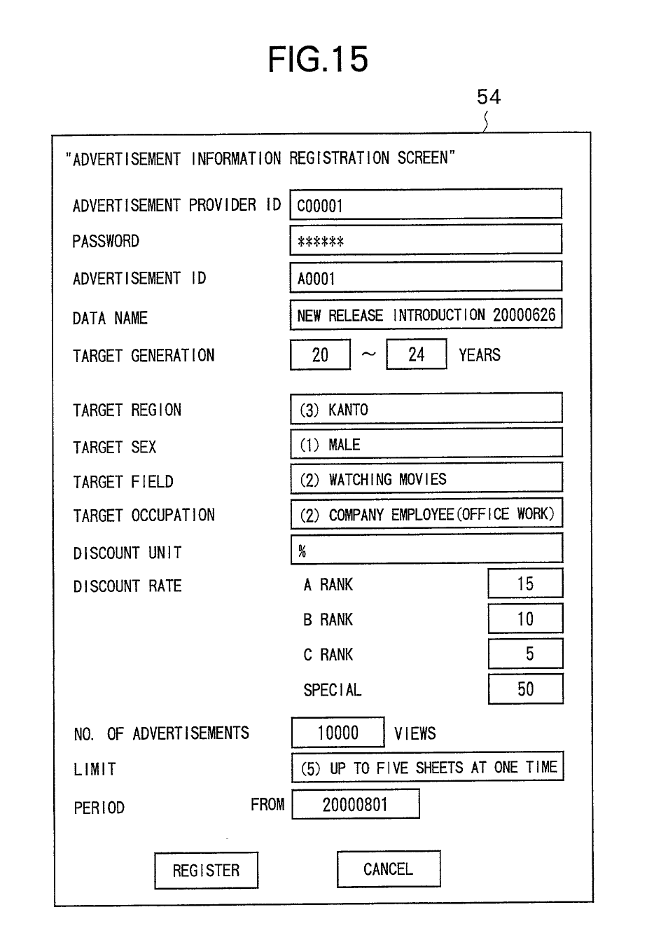

In step 21, an advertisement information registration screen 54 such as shown in FIG. 15 is displayed on the terminals 20b and 20c of the advertiser. The advertisement information registration screen 54 comprises an input section for inputting advertisement provider ID, password, and provider advertisement information, a “register” button, and a “cancel” button. Here “provider advertisement information” means various information which specify advertisement information such as; advertisement ID, data name, target generation, target region, target sex, target field, target occupation, discount unit, discount rate, advertisement number, limit, and period. Furthermore, “discount rate” means the rate for discounting for example, a movie picture fee, corresponding to the utilization frequency or the like of the card sending service, in order to improve the customer attraction by the advertisement information. “Advertisement number” and “limit” respectively mean, the upper limit for the number of times of providing the advertisement information, and the limit on the number of cards which can be sent at once.

In step 22, the advertisement provider ID and password are input.

In step 23, it is judged whether or not the advertisement provider ID and password are valid. Then, if the advertisement provider ID and password are valid, control proceeds to step 24 (Yes), while if the advertisement provider ID and password are not valid, control returns to step 22 (No), and re-input of the advertisement provider ID and password is prompted.

In step 24, the provider advertisement information is input. Here for “target region”, “target sex”, “target field”, “target occupation”, and “limit” are selected from amongst a plurality of previously set headings, as being considered most suitable.

In step 25, when the “register” button is pressed, it is judged whether or not the provider advertisement information is valid. Then, if the provider advertisement information is valid, control proceeds to step 26 (Yes), while if the provider advertisement information is not valid, control returns to step 24 (No), and re-input of the provider advertisement information is prompted.

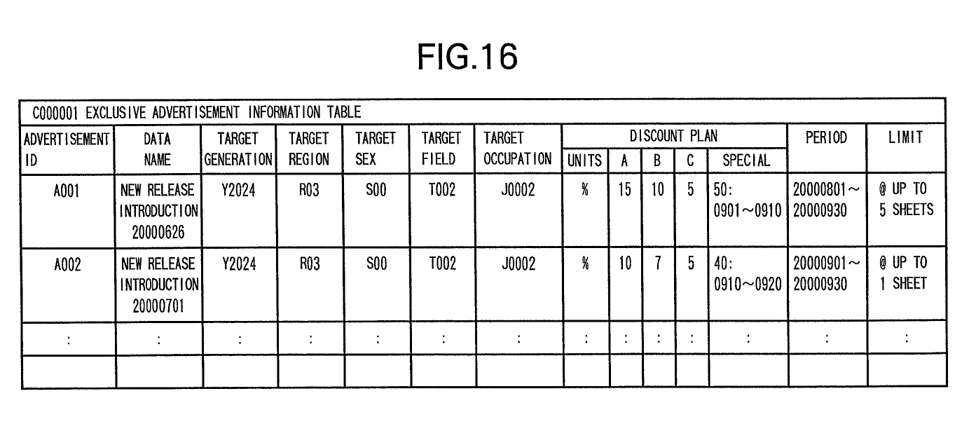

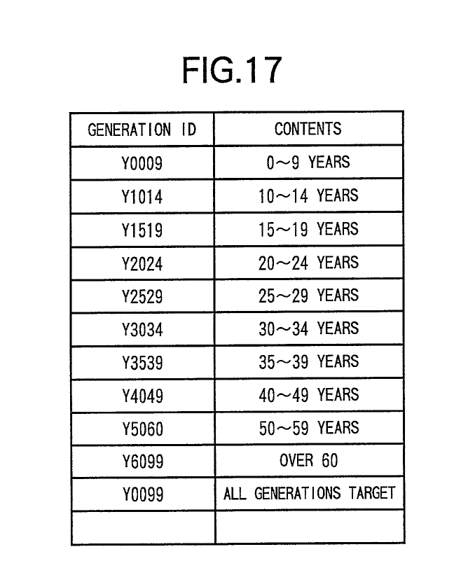

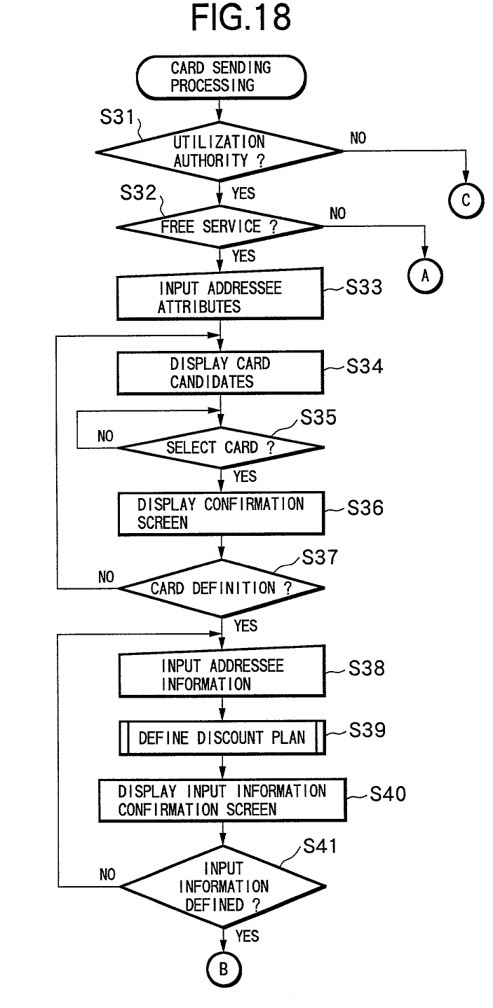

In step 26, the input provider advertisement information is registered in an advertisement information table (refer to FIG. 16) of the advertisement information DB 14c. Here in the “target generation” section in the advertisement information table, is registered a generation ID corresponding to an input target generation, from reference to a generation table such as shown in FIG. 17 based on the input target generation. Furthermore, in the “target region”, “target sex”, “target field” and the “target occupation” sections, are respectively registered the IDs prescribed in; the region table (FIG. 10), the sex table (FIG. 6), the target field table (FIG. 9) and the target occupation table (FIG. 8).

With the above described processing of step 21 through step 26, the advertisement provider such as a business, inputs the provider advertisement information from the terminals 20b and 20c of the advertiser, and these contents are registered in the advertisement information DB 14c. At this time, since for each piece of advertisement information the target generation, target region, target sex, target field, target occupation and the like are registered, a consumer as a target of advertisement providing, can be effectively selected, and hence effective publicizing by the advertisement information can be performed. Moreover, by setting the advertisement number, the limit, and the period etc., then the advertisement provider can perform publicizing activities corresponding to the publicizing budget of the company itself.

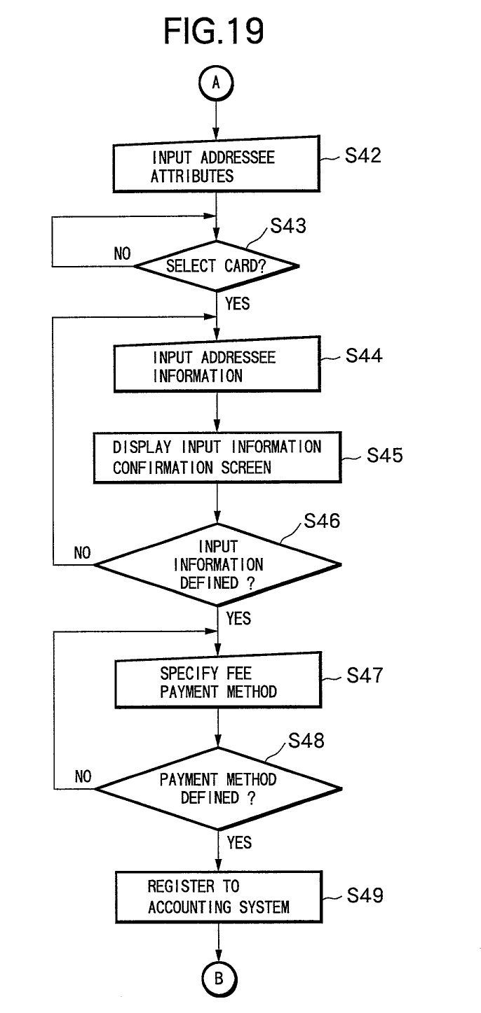

FIG. 18 through FIG. 20 are flowcharts showing the card sending processing. Here “card sending processing” means various processing for realizing the card sending service.

In step 31, it is judged whether or not the person (hereunder referred to as the “sending client”) who intends to send, using the card sending service, a card to a person such as a friend, has correct user authority. That is to say, when the member ID and password are input on the Web site of the card sending service, the member information DB 14a is retrieved with the member ID as the retrieval condition, and the password corresponding to the member ID is obtained. Then, if the input and the obtained passwords agree to each other, it is judged that the sending client is a registered client having the correct utilization authority, and control proceeds to step 32 (Yes). On the other hand, when the member ID is not registered in the member information DB 14a, or the passwords do not agree to each other, it is judged that the sending client does not have the correct utilization authority, and after for example displaying a message prompting member registration, the card sending processing is terminated (No).

In step 32, it is judged whether or not the sending client desires a free service. Here “free service” means a service where the cost required for card sending is free in return for attaching advertisement information to the card. Moreover, as a service in contrast to this, there is a “fee service”. “Fee service” means a service where in return for not attaching advertisement information to the card, a cost required for card sending must be charged. Then, if a free service is desired, control proceeds to step 33 (Yes), while if a fee service is desired, control proceeds to step 44 (No). Here the free service or the fee service are selectively specified for example in the screen to which the member ID and password are input.

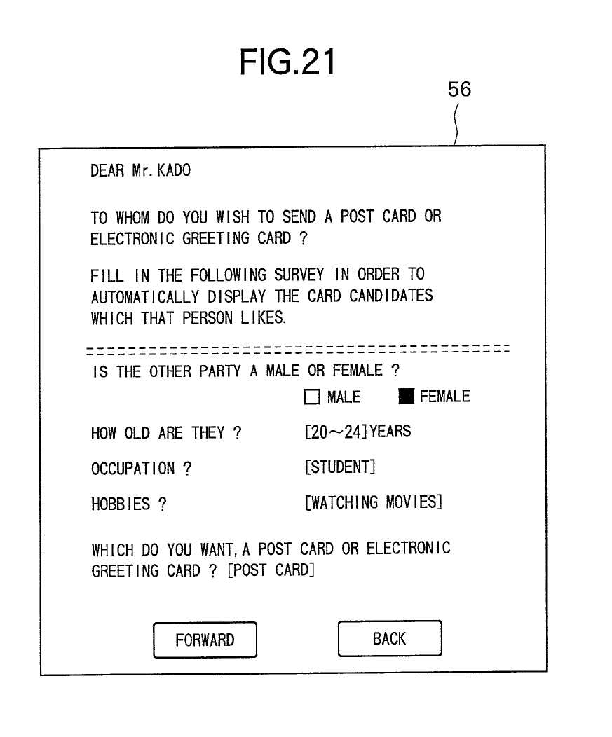

In step 33, an addressee attribute input screen 56 such as shown in FIG. 21 is displayed on the terminal 20a of the consumer. The addressee attribute input screen 56 comprises; an input section for specifying the addressee attributes and type of card, a “forward” button, and a “back” button. Here “addressee attributes” means the various information from which the preference trends of the addressee can be estimated. More specifically, this means information such as sex, generation, occupation and hobbies etc., which cannot specify an individual. Then, the addressee attributes and the type of card are input in the addressee attribute input screen 56. Here the first preference trend input means is realized by the processing of step 33.

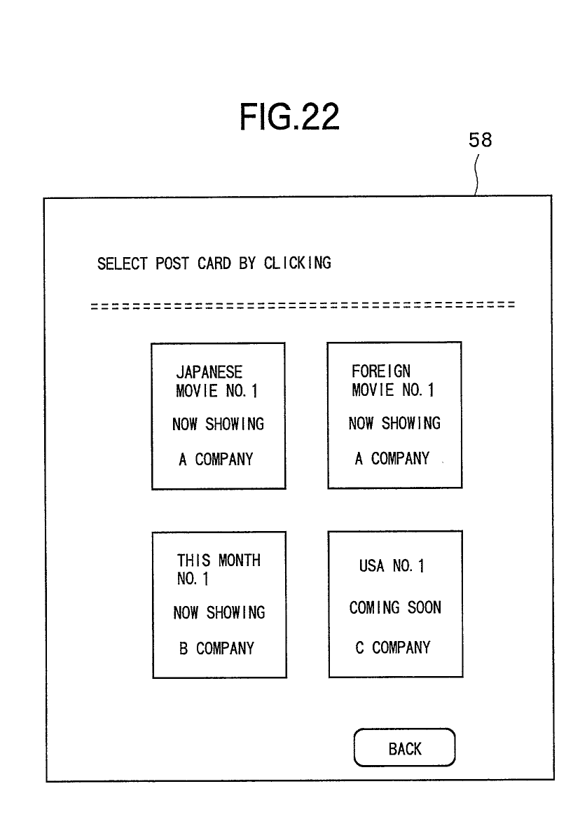

In step 34, the advertisement information table (FIG. 16) of the advertisement information DB 14c is retrieved based on the addressee attributes, and at least one piece of the advertisement information thought to be of interest to the addressee is selected. Then, the selected advertisement information is list displayed on a card selection screen 58 such as shown in FIG. 22, as a card candidate for selection by the sending client. When the “back” button of the card selection screen 58 is pressed, control returns to the previous processing, that is to say to the addressee attribute input processing (step 33). Here the advertisement information display means is realized by the processing of step 34.

In step 35, it is judged whether or not one card has been selected from amongst the card candidates displayed on the card selection screen 58. Card selection is performed by clicking on the displayed card. Then, if a card has been selected, control proceeds to step 36 (Yes), while if a card has not been selected, the processing of step 35 is repeatedly executed (No). Here the advertisement information selection means is realized by the processing of step 35.

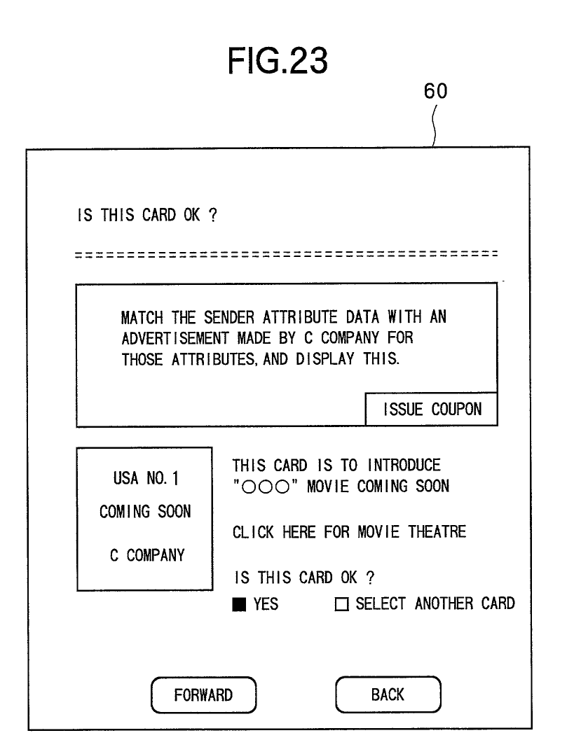

In step 36, a card confirmation screen 60 such as shown in FIG. 23 is displayed on the terminal 20a of the consumer. The card confirmation screen 60 comprises; a user directed advertisement display section, a sending card display section, a card confirmation section, a “forward” button, and a “back” button. On the user directed advertisement display section is displayed advertisement information for which the sending client is thought to have an interest. That is to say, the advertisement information table (FIG. 16) of the advertisement information DB 14c is retrieved based on the personal information registered in the member information table (FIG. 5) of the member information DB 14a, and the optimum advertisement information set as the advertisement provider target by the advertisement provider is selected. Then the selected advertisement information is displayed in the user directed advertisement information display section. Furthermore, a “coupon issue” button is disposed in the user directed advertisement information display section, and by clicking this, coupon issue processing is executed for issuing a product or service discount coupon (discount ticket). A description is given later in relation to the coupon issue processing. On the other hand, in the card confirmation section it is specified if the card displayed in the sending card display section is suitable or not. The advertisement information selection means, the second advertisement information selection means and the advertisement information presentation means are realized by the processing of step 36.

Here an advertisement information presentation step and an advertisement information presentation function are realized by the processing of step 3 (refer to FIG. 3) and step 36.

In step 37, it is judged whether or not a card defining operation has been carried out. That is to say, when a “Yes” is selected in the card confirmation section and the “forward” button is pressed, it is judged that the card defining processing has been executed, and control proceeds to step 38 (Yes). On the other hand, when “select another card” is selected in the card confirmation section and the “forward” button is pressed, or when the “back” button is pressed, control returns to step 34 (No), and the card candidates are again displayed.

Here a first advertisement information selection means is realized by the processing of step 34 through step 37.

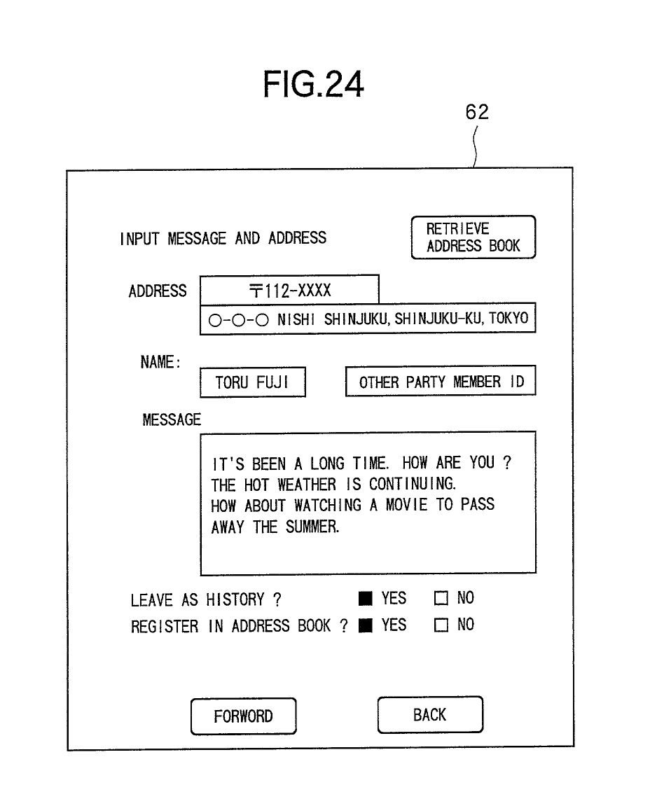

In step 38, an addressee information input screen 62 such as shown in FIG. 24 is displayed on the terminal 20a of the consumer. The addressee information input screen 62 comprises; an address input section for inputting the address and name of the addressee, a message input section for inputting messages, a history specifying section for specifying whether or not a history is to be saved, an address book registration specifying section for specifying whether or not the address is to be registered in the address book, a “forward” button, and a “back” button. An “address book retrieve” button is disposed in the address input section, and on pressing this, an address book is displayed, so that the card destination can be input with one touch from amongst the addresses registered therein. Furthermore, an “other party member ID” input box is also provided in the address input section. In the case where the member ID of the addressee is known, then the member ID is input here, thereby enabling simplification of the address input. Then, after inputting the address, a message and so on, if the “forward” button is pressed, control proceeds to step 39, while if the “back” button is pressed, control returns to step 34.

In step 39, a subroutine for defining a discount plan for a coupon affixed with the advertisement information is called. Here the discount plan defining processing is described later.

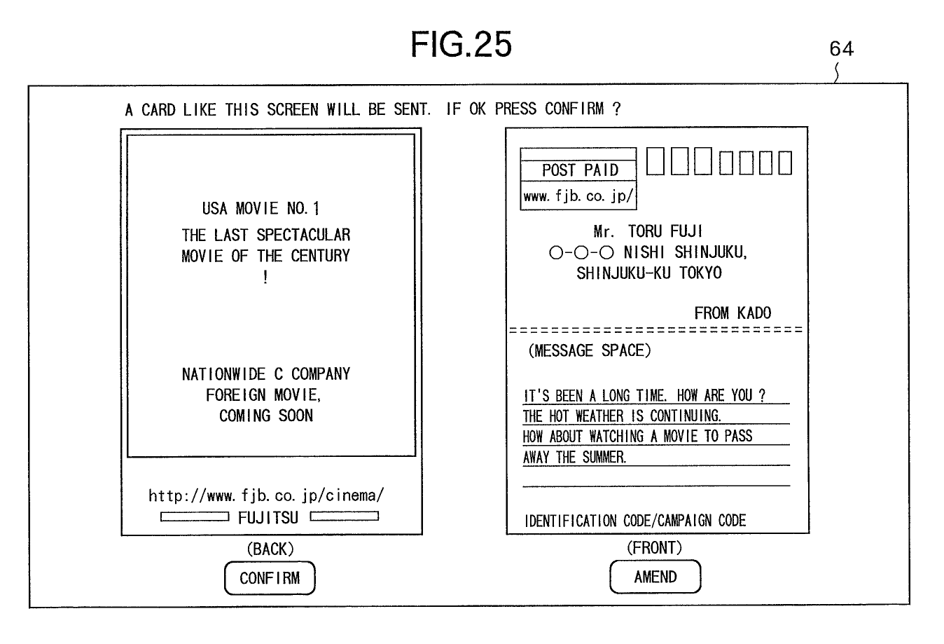

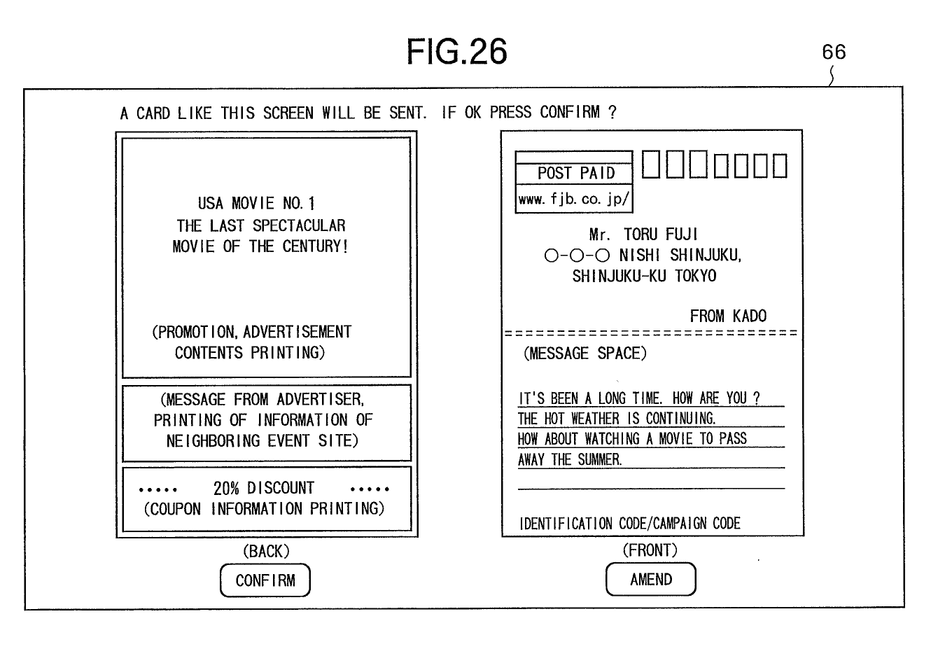

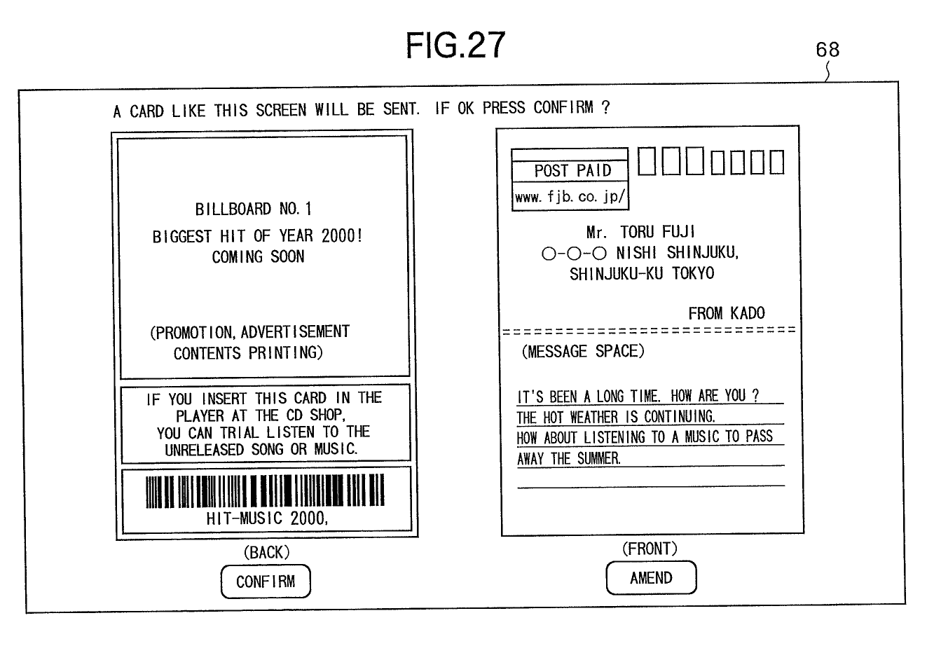

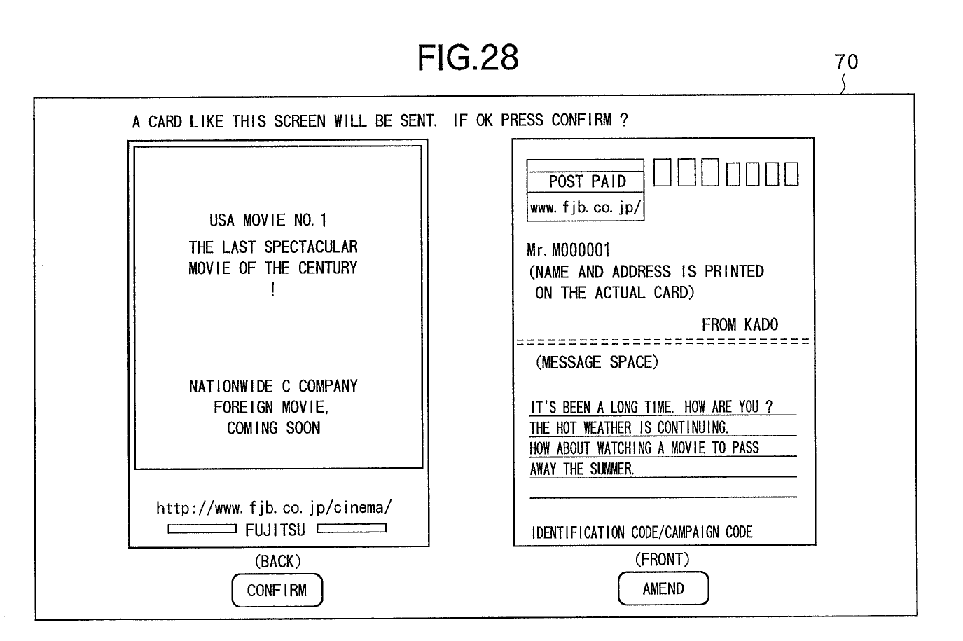

In step 40, input information confirmation screens 64˜70 such as shown in FIG. 25 through FIG. 28 are displayed on the terminal 20a of the consumer. The input information confirmation screens 64 through 70 are displayed with different layouts depending for example on the presence of a coupon, or the input of an address for the member ID. More specifically, display examples are respectively shown with; FIG. 25 for the case where there is no coupon, FIG. 26 for the case where there is a coupon and a message from the advertiser, FIG. 27 for the case where advertisement identification information such as a bar code is attached, and FIG. 28 for the case where an address for the member ID is input. Here, with the input information confirmation screen 70 where an address is input for the member ID, instead of displaying a specific address which specifies the addressee, only the member ID is displayed.

In step 41, it is judged whether or not the defining operation for the input information has been performed. That is to say, in the input information confirmation screens 64 through 70 shown in FIG. 25 through FIG. 28, if the “confirm” button is pressed, it is judged that the defining operation for the input information has been made, and control proceeds to step 50 for printing or creating the card (Yes). On the other hand, in the input information confirmation screens 64 through 70, if the “correct” button is pressed, control returns to step 38 (No), and the input processing for the addressee information is again executed.

In step 42 for providing the card sending service at a fee, the addressee attribute input screen 56 such as shown in FIG. 21 is displayed on the terminal 20a of the consumer. Then, the addressee attributes and the type of card are input in the addressee attribute input screen 56.

In step 43, it is judged whether or not a card has been selected. That is to say, in the card selection screen (not shown in the figure) displayed on the terminal 20a of the consumer, it is judged whether nor not “card” has been clicked. Then, if a card has been selected, control proceeds to step 44 (Yes), while if a card has not been selected, the processing of step 43 is repeatedly executed (No).

In step 44, the addressee information input screen 62 such as shown in FIG. 24 is displayed on the terminal 20a of the consumer. Then, after inputting the address, a message and so on, if the “forward” button is pressed, control proceeds to step 45, while if the “back” button is pressed, control returns to step 42.

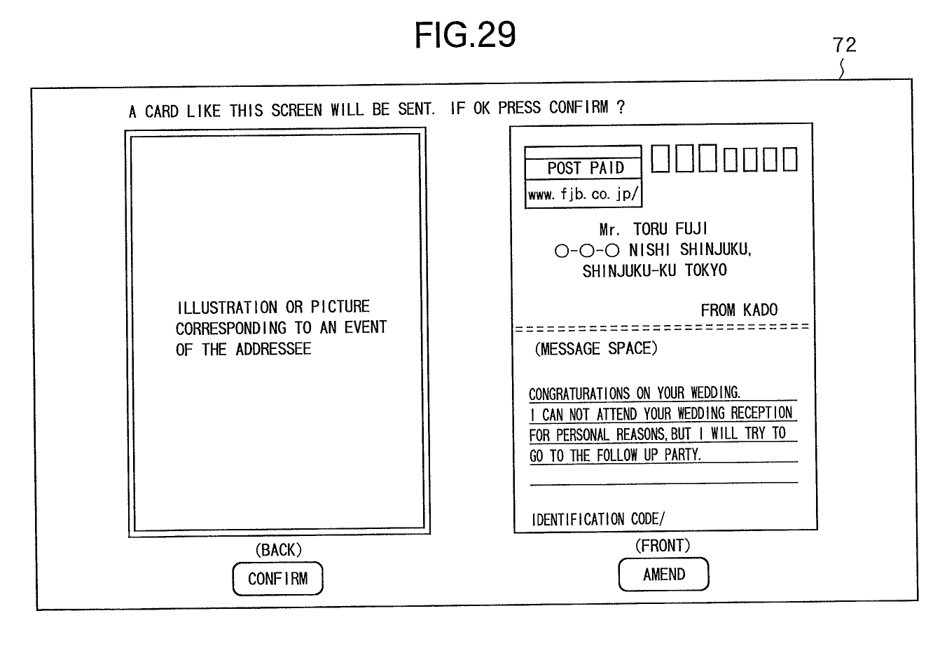

In step 45, an input information confirmation screen 72 such as shown in FIG. 29 is displayed on the terminal 20a of the consumer. Here, differently from the postcard of the free service such as shown in FIG. 25 through FIG. 28, with the postcard of the fee service, the advertisement information of the business or the like is not attached.

In step 46, it is judged whether or not the defining operation for the input information has been performed. That is to say, in the input information confirmation screen 72, if the “confirm” button is pressed, it is judged that the defining operation for the input information has been made, and control proceeds to step 47 (Yes). On the other hand, in the input information confirmation screen 72, if the “correct” button is pressed, control returns to step 44 (No), and the input processing of the addressee information is again executed.

In step 47, a payment method specifying screen (not shown in the figure) for specifying the fee payment method, is displayed on the terminal 20a of the consumer. Here for the fee payment method, there is for example fee transfer from a convenience store or a bank, or settlement with a credit card. Then, in the payment method specifying screen, the payment method desired by the sending client is specified.

In step 48, it is judged whether or not the defining operation of the fee payment method has been performed. Then, once the fee payment method has been defined, control proceeds to step 49 (Yes), while if the fee payment method has not been defined, control returns to step 47 (No).

In step 49, the fee for the card sending service, and the payment method therefor are registered in an accounting system (not shown in the figures).

In step 50 where printing or creation of the card is performed, the addressee information is temporarily stored in the memory.

In step 51, addressee information is extracted from the addressee information temporarily stored in the memory.

In step 52, a post card is printed or an electronic greeting card is created based on the extracted addressee information and the card selected in step 35 or step 43. Here, at the time of the free service, advertisement information which is thought to be of interest to the addressee, based on personal information registered in the member information DB 14a, or on input addressee attributes, is attached to the card to be sent. The printed or created card is such as shown in FIG. 25 through FIG. 29.

In step 53, it is judged whether or not ones own address is specified, that is to say, whether or not specification for also sending the card to ones own address has been performed. Whether or not to send the card to ones own address can be specified for example in the addressee information input screen 62 shown in FIG. 24. Then, if ones own address has been specified, control proceeds to step 54 (Yes), while ones own address has not been specified, control returns to step 56 (No).

In step 54, the member information table (FIG. 5) of the member information DB 14a is retrieved, and the addressee information for the sending client is acquired.

In step 55, printing of a postcard or creation of an electronic greeting card is performed based on the acquired addressee information and the card selected in step 35 or step 43.

Here, advertisement information adding means and advertisement identification information adding means are realized by the processing of step 52 and step 55. Furthermore, an advertisement information adding step and an advertisement information adding function are realized by the processing of step 33 through step 37 (refer to FIG. 18) and step 52 and step 55.

In step 56, it is judged whether or not to register the history related to the card sending. That is to say, it is judged whether or not in the addressee information input screen 62 shown in FIG. 24, specification has been made to save the history related to card sending. Then, if the history is to be registered, control proceeds to step 54 (Yes) and the history related to card sending is registered for example in the history information DB (not shown in the figure) serving as sending history storgeneration means. On the other hand, if the history is not to be registered, control proceeds to step 58 (No).

Here the registered history is used, for example at the time of sending the card, to avoid providing the same advertisement information to the same addressee. That is to say, when advertisement information is selected from the advertisement information DB 14c, the history related to that addressee is referred to, so that it is possible to prevent advertisement information which has been once provided, from again being provided. Therefore, provision of duplicate advertisement information can be prevented, enabling effective publicizing activity to be performed.

In step 58, it is judged whether or not the addressee information is to be registered in the address book. That is to say, it is judged whether or not in the addressee information input screen 62 shown in FIG. 24, specification has been made to register addressee information in the address book. Then, if the addressee information is to be registered in the address book, control proceeds to step 59 (Yes), and the addressee information is registered in the address book. On the other hand, if the addressee information is not to be registered in the address book, control proceeds to step 60 (No). Here the registered address book is used for alleviating the load for inputting addressee information for the addressee in the addressee information input screen 62 shown in FIG. 24.

In step 60, the printed post card or the created electronic greeting card is sent to the specified addressee via post or electronic mail.

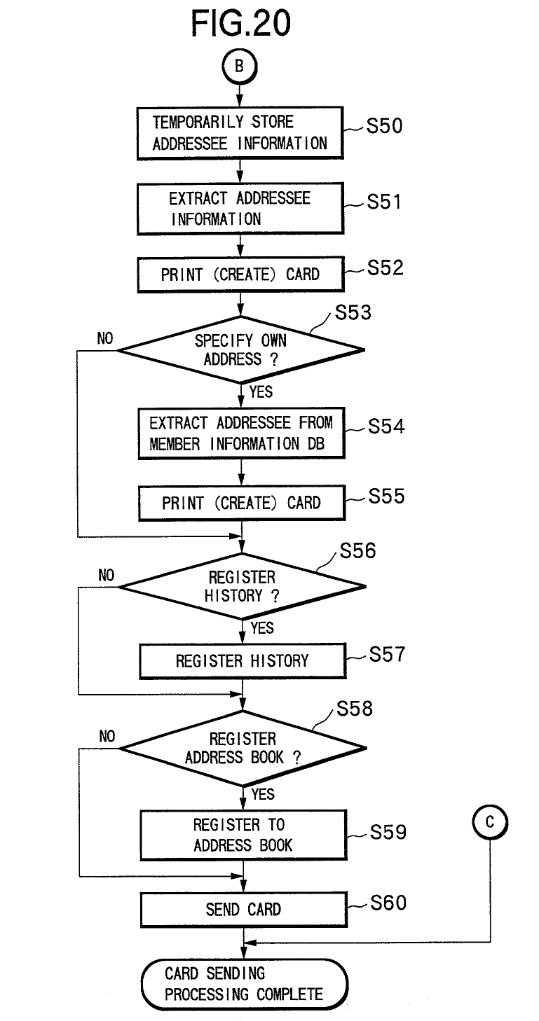

Here card sending means, a card sending step and a card sending function are realized by the processing of step 53 through step 55 (refer to FIG. 20) and step 60.

With the processing of step 31 through step 60 as described above, for a user desiring a free card sending service, the input of the addressee attributes which express addressee hobbies and so on is requested. When the addressee attributes are input, the advertisement information DB 14c is retrieved based on the addressee attributes, and at least one piece of the advertisement information thought to be of interest to the addressee is selected, and displayed on the screen as a card candidate. Then, when one card is selected from amongst the displayed card candidates, a card confirmation screen for confirming the card to be sent, is displayed. At this time, user directed personal advertisement information is displayed on the card confirmation screen. With the user directed personal advertisement information, the advertisement information DB 14c is retrieved based on the personal information registered in the member information DB 14a, and advertisement information thought to be of interest to the sending client is selected. Then, when the addressee information of the addressee is input, a card laid out in accordance with the presence or absence of a coupon or the like is displayed, and confirmation and definition of the card contents is performed.

On the other hand, for a user desiring a fee card sending service, as with the free service, the input of the addressee attributes and addressee information, and card selection for selecting one card from amongst card candidates, is requested. Moreover, the method whereby the sending client is to pay the fee for the card sending service is specified, and the fee information is registered in the accounting system. In this case, preferably user directed advertisement information is displayed on a screen such as; the screen for input of addressee attributes and addressee information, the card selection screen, or the screen for specifying the fee payment method.

Then, based on the defined card contents, printing of the postcard or creation of the electronic greeting card is performed, and the card is sent to the specified addressee via post or electronic mail.

Therefore, advertisement information thought to be of interest to the addressee is attached to the card to be sent by the free card sending service, and the addressee thus pays attention to the advertisement information so that their retention probability is increased. Consequently, for the advertisement provider of the business or the like, the publicizing effect for the advertisement information can be improved, and efficient publicizing activity can be performed. On the other hand, for the user of the card sending service, cards can be sent for free via the Internet 40, and hence expense and time required for card sending can be alleviated.

Furthermore, in the case of using a fee card sending service, by accessing the Web site of the card sending service in ones home or the like via the Internet 40, a card attached with a message can be sent to persons such as friends. Therefore, in the case of sending a post card, it is not necessary to purchase a card and stamp and mail the card, and hence the time required for card sending can be alleviated.

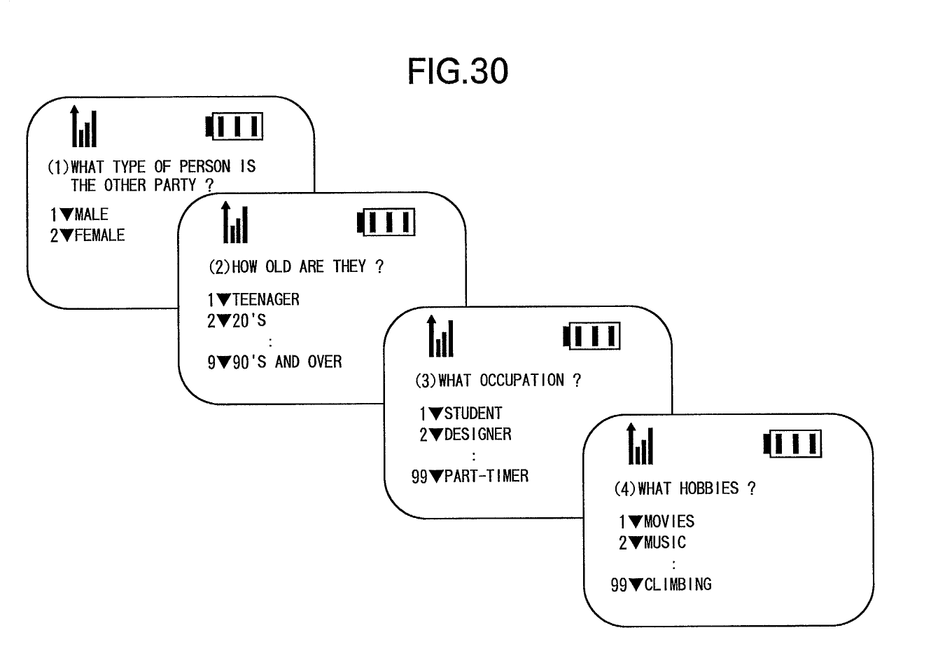

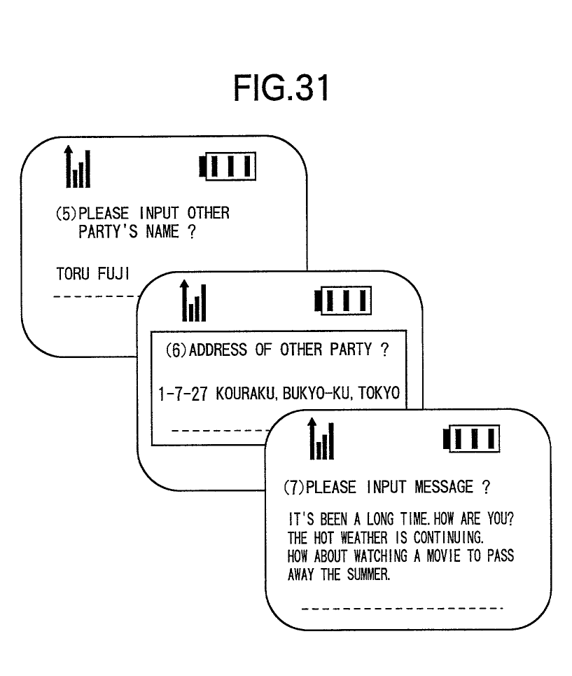

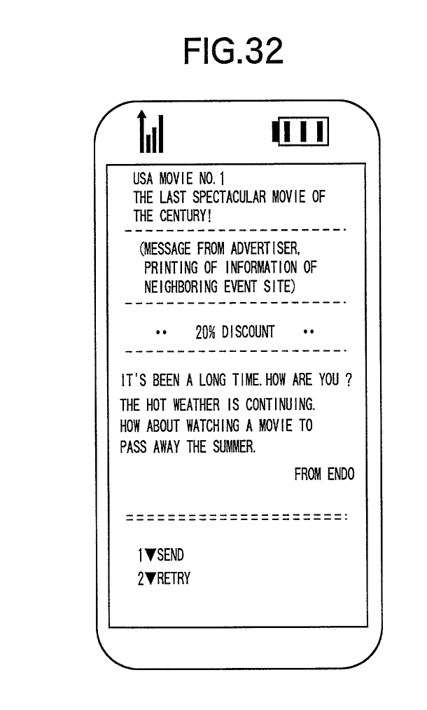

Here in the above described card sending processing, the configuration is such that various operations related to card sending are performed on the terminal 20a of the consumer. However as shown in FIG. 30 through FIG. 32, card sending operations may be performed on a mobile communication terminal.

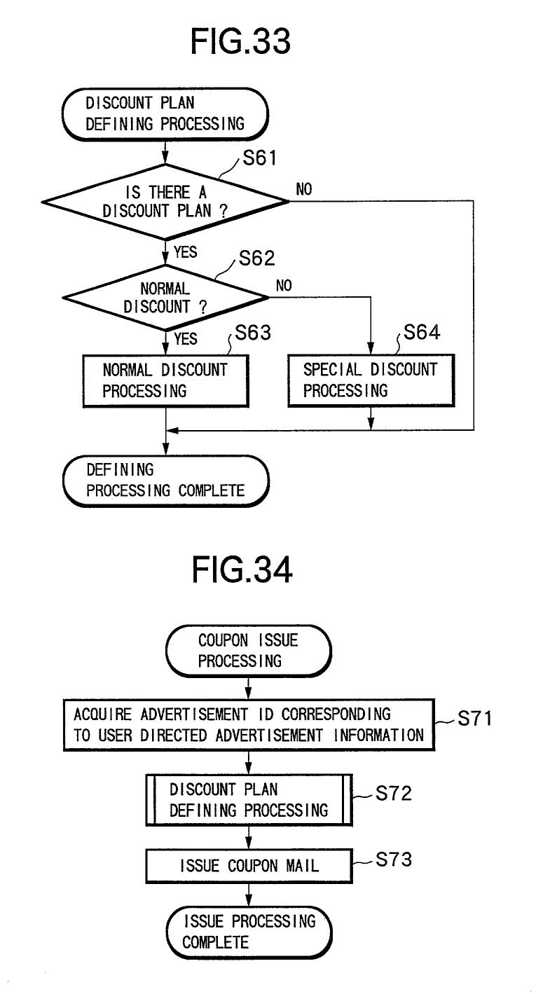

FIG. 33 is a flowchart showing discount plan defining processing for defining a coupon discount plan.

In step 61, the advertisement information table (FIG. 16) of the advertisement information DB 14c is retrieved based on the advertisement ID for advertisement information which becomes the discount plan defining target, and it is judged whether or not a discount plan has been set. Then, if a discount plan has been set, control proceeds to step 62 (Yes), while if a discount plan has not been set, the discount plan defining processing is terminated with “No discount”.

In step 62, it is judged whether or not there is a normal discount. Here “normal discount” means a discount set in response to utilization frequency or the like of a sending client. Furthermore, contrary to “normal discount”, there is also “special discount”. This means a discount for a term limit. Whether or not the discount plan is a normal discount is judged by examining if a discount plan of a term limit is set with respect to use day of the card sending service or not, in the advertisement information table shown in FIG. 16. Then, if the discount plan is a normal discount, control proceeds to step 63 (Yes), while if the discount plan is a special discount, control proceeds to step 64 (No).

In step 63, the discount plan is defined as a normal discount. That is to say, the member information table (FIG. 5) of the member information DB 14a is retrieved based on the member ID of the sending client, and the utilization frequency is acquired. Then the advertisement information table (FIG. 16) of the advertisement information DB 14c is retrieved, based on the advertisement ID and the utilization frequency, and the discount plan for normal discount is defined. For example, when the advertisement ID is “A001” and the utilization frequency is “12 times”, the discount plan is defined as being “10%”. Here additional information change means, an additional information change step and an additional information change function are realized by the processing of step 63.

In step 64, the discount plan for the special discount is defined. That is to say, the advertisement information table (FIG. 16) of the advertisement information DB 14c is retrieved based on the use day of the card sending service, and the discount plan of the special discount is defined. For example, when the advertisement ID is “A002”, and the use day of the card sending service is “September 13, 2000”, it is determined that the discount plan is “40%”.

With the processing of step 61 through step 64 as described above, for the product or service specified by the advertisement information, the discount plan is defined based on the utilization frequency of the sending client and the use day of the card sending service. The discount plan, as shown in the advertisement information table of FIG. 16, is set so that the discount rate is increased with an increase in the utilization frequency. Therefore an increase in the utilization frequency of the card sending service can be expected. Hence for the business or the like providing the advertisement information, cards with the advertisement information attached can be provided to even more consumers.

FIG. 34 is a flowchart showing the coupon issue processing which is executed when the “coupon issue” button is pressed in the card confirmation screen 60 shown in FIG. 23.

In step 71, an advertisement ID corresponding to user directed advertisement information displayed on the card confirmation screen 60 is acquired.

In step 72, a subroutine for defining the discount plan is called. Here the advertisement information which becomes the discount plan defining target, can be specified for example by calling a subroutine with the advertisement ID acquired in step 71 as an argument.

In step 73, coupon mail affixed with a predetermined discount plan is issued to the mail address registered in the member information table (FIG. 5) of the member information DB 14a.

According to the processing of step 71 through step 73 described above, the user of the card sending service presses the “coupon issue” button disposed in the user directed advertisement information, to thereby acquire a product or service coupon related to the advertisement information. In this case, by examining the coupon issue frequency, the interest of the consumer in the advertisement information can be known, and this can be used in the next publicizing strategy.

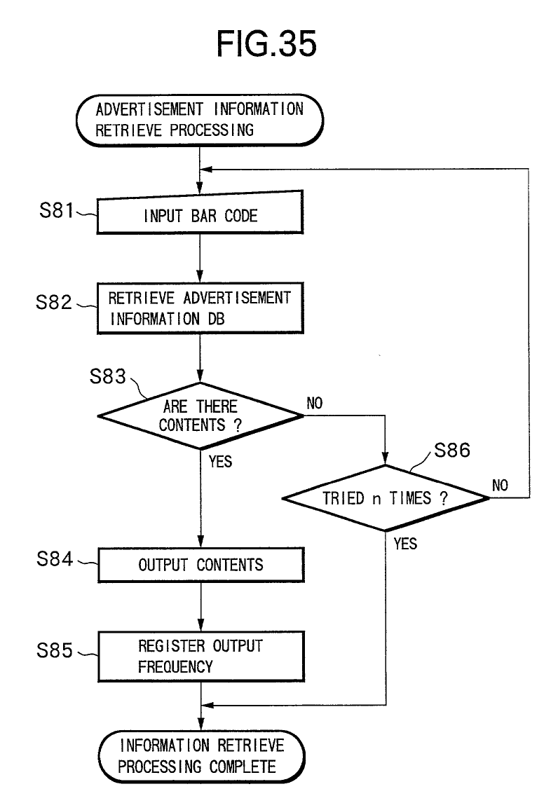

FIG. 35 is a flowchart showing the advertisement information retrieval processing for retrieving advertisement identification information attached to a card in the shop system 30 shown in FIG. 1, and providing advertisement information to a consumer. With the advertisement information retrieval processing, if for example the advertisement information is a bar code showing a new song to be released, then this is the processing for providing a service for a trial listening of this new song.

In step 81, advertisement identification information such as for a bar code attached to a card is input in the shop system 30.

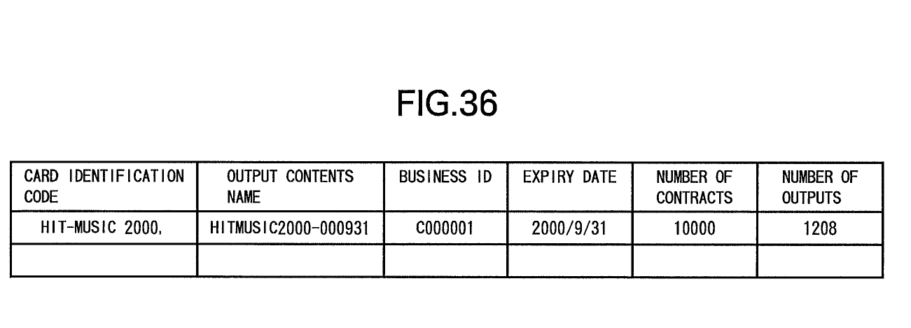

In step 82, a shop system linked advertisement information table (refer to FIG. 36) of the advertisement information DB 14c is retrieved based on the card identification code identified by the input advertisement identification information. In the shop system linked advertisement information table, as shown in the figure, is registered for example; output contents name corresponding to the card identification code, business ID, expiration date, number of contracts and number of outputs.

In step 83, it is judged whether or not contents corresponding to the card identification code are registered in the shop system linked advertisement information table. Then, if contents are registered, control proceeds to step 84 (Yes), while if contents are not registered, control proceeds to step 86 (No).

In step 84, the advertisement information DB 14c is retrieved based on the output contents name registered in the shop system linked advertisement information table, and contents identified by the advertisement identification information are output.

In step 85, the number of outputs of the shop system linked advertisement information table is incremented.

In step 86, it is judged whether or not retrieval of the advertisement information DB 14c has been performed a predetermined number of times n. When retrieval of the advertisement information DB 14c is missed due for example to a momentary failure of the power supply, then an immediate judgment that the contents were not registered would lower the reliability of the system. Therefore, by judging that the contents have not been registered, only when the contents are not found even if the search of the advertisement information DB 14c has been performed n times, the reliability of the system can be improved.

Here second advertisement information output means is realized by the processing of step 81 through step 86. Furthermore, a second advertisement information output step and a second advertisement information output function are realized by the processing of step 52, step 55 (refer to FIG. 20) and step 81 through step 86.

With the processing of step 81 through step 86 as described above, the addressee who has received a post card via the card sending service, inputs the advertisement identification information attached to the card into the shop system 30. As a result the advertisement information identified by the advertisement identification information can be used. Therefore, even with non-visual advertisement information which cannot be shown on a card, such as music or imgenerations, the addressee can use this, and this thus contribute to the convenience of the user. On the other hand, also for a business, advertisement information which could not be transmitted with the current DM (direct mailing) can also be transmitted, and a new publicizing format can be constructed.

When the same card is sent to the sending client and the addressee, by inputting advertisement identification information attached to the respective cards, simultaneously to the terminals 20b and 20c of the advertiser, then a special privilege for outputting specific advertisement information can be received. Here first advertisement information output means, a first advertisement information output step and a first advertisement information output function are realized by such processing. In this case, the customer attraction for the card is improved, and the publicizing effect for the advertisement information is further improved.

If a program for realizing such functions is recorded for example on a computer readable recording medium such as a magnetic tape, a magnetic disc, a magnetic drum, and IC card, a CD-ROM, a DVD-ROM or the like, then the advertisement information providing program according to the present invention can be distributed in the market. Then, a person who acquires such a recording medium can easily construct the advertisement information providing system according to the present invention, using a standard computer.

What is claimed is:

1. An advertisement information providing system comprising:
card sending service providing means for providing a card sending service for sending a card attached with an optional message to a specified addressee;
first preference trend input means for inputting preference trends of said addressee;
first advertisement information selection means for selecting advertisement information suitable for the preference trends of the addressee input by said first preference trend input means; and
advertisement information adding means for adding advertisement information selected by said first advertisement information selection means to said card.

2. An advertisement information providing system according to claim 1, further comprising:
second preference trend input means for inputting preference trends of a card sending client;
second advertisement information selection means for selecting advertisement information suitable for the preference trends of said sending client input by said second preference trend input means; and
advertisement information presentation means for presenting advertisement information selected by said second advertisement information selection means to said sending client.

3. An advertisement information providing system according to claim 1, wherein said first advertisement information selection means comprises:
advertisement information display means for selecting a plurality of advertisement information suitable for the preference trends of the addressee input by said first preference trend input means, and displaying a plurality of advertisement information selected for said sending client; and
advertisement information selection means for making said sending client select one piece of advertisement information from amongst the plurality of advertisement information displayed by said advertisement information display means.

4. An advertisement information providing system according to claim 1, wherein there is provided sending history storgeneration means for storing card sending history for said sending client, and said first advertisement information selecting means, based on the card sending history stored by said sending history storgeneration means, selects advertisement information suitable for the preference trends of the addressee, except for advertisement information which has already been provided to said addressee.

5. An advertisement information providing system according to claim 1, wherein there is further provided:
utilization frequency counting means for counting utilization frequency of the card sending service by said sending client; and
additional information change means for changing additional information to be added to said card, based on the utilization frequency counted by said utilization frequency counting means.

6. An advertisement information providing system according to claim 5, wherein there is further provided:
card sending means for sending a card attached with said advertisement information and said additional information to said sending client; and
first advertisement information output means for outputting advertisement information specified by said additional information, by simultaneously inputting additional information added to the card sent to said addressee and additional information added to the card sent to said sending client.

7. An advertisement information providing system according to claim 1, wherein there is further provided:
advertisement identification information adding means for adding advertisement identification information for identifying non-visual advertisement information to said card; and
second advertisement information output means for outputting non-visual advertisement information specified by said advertisement identification information, based on advertisement identification information added by said advertisement identification information adding means.

8. An advertisement information providing system comprising:
card sending service providing means for providing a card sending service for sending a card attached with an optional message to a specified addressee;
preference trend input means for inputting preference trends of a card sending client;
advertisement information selection means for selecting advertisement information suitable for the preference trends of said sending client input by said preference trend input means; and
advertisement information presentation means for presenting advertisement information selected by said advertisement information selection means to said sending client.

9. An advertisement information providing method comprising:
a card sending service providing step for providing a service for sending a card attached with an optional message to a specified addressee;
an advertisement information adding step for inputting preference trends of said addressee, selecting advertisement information suitable for the input preference trends of said addressee, and adding selected advertisement information to said card; and
an advertisement information presenting step for inputting preference trends of a card sending client, selecting advertisement information suitable for the input preference trends of said sending client, and presenting selected advertisement information to said sending client.

10. An advertisement information providing method according to claim 9, wherein said advertisement information adding step selects a plurality of advertisement information suitable for the input preference trends of the addressee, displays a plurality of advertisement information selected for said sending client, and makes said sending client select one piece of advertisement information from amongst the displayed plurality of advertisement information.

11. An advertisement information providing method according to claim 9, wherein said advertisement information adding step, based on card sending history for said sending client, selects advertisement information suitable for the preference trends of said addressee except for advertisement information which has already been provided to said addressee.

12. An advertisement information providing method according to claim 9, wherein there is further provided an additional information change step for changing additional information to be added to said card, based on the utilization frequency of the card sending service by said sending client.

13. An advertisement information providing method according to claim 12, wherein there is further provided:
a card sending step for sending a card added with said advertisement information and said additional information to said sending client; and
a first advertisement information output step for outputting advertisement information specified by said additional information, by simultaneously inputting additional information added to the card sent to said addressee and additional information added to the card sent to said sending client.

14. An advertisement information providing method according to claim 9, wherein there is further provided;
a second advertisement information output step for adding advertisement identification information for identifying non-visual advertisement information to said card, and outputting non-visual advertisement information specified by said advertisement identification information, based on the added advertisement identification information.

15. A computer readable recording medium recorded with an advertisement information providing program for realizing on a computer:
a card sending service providing function for providing a card sending service for sending a card attached with an optional message to a specified addressee;
an advertisement information adding function for inputting preference trends of said addressee, selecting advertisement information suitable for the input preference trends of said addressee, and adding selected advertisement information to said card; and
an advertisement information presenting function for inputting preference trends of a card sending client, selecting advertisement information suitable for the input preference trends of said sending client, and presenting selected advertisement information to said sending client.

16. A computer readable recording medium recorded with an advertisement information providing program according to claim 15, wherein said advertisement information adding function selects a plurality of advertisement information suitable for the input preference trends of the addressee, displays a plurality of advertisement information selected for said sending client, and makes said sending client select one piece of advertisement information from amongst the displayed plurality of advertisement information.

17. A computer readable recording medium recorded with an advertisement information providing program according to claim 15, wherein said advertisement information adding function, based on card sending history for said sending client, selects advertisement information suitable for the preference trends of said addressee except for advertisement information which has already been provided to said addressee.

18. A computer readable recording medium recorded with an advertisement information providing program according to claim 15, wherein there is further provided an additional information change function for changing additional information to be added to said card, based on the utilization frequency of the card sending service by said sending client.

19. A computer readable recording medium recorded with an advertisement information providing program according to claim 18, wherein there is further provided:
a card sending function for sending a card added with said advertisement information and said additional information to said sending client; and
a first advertisement information output function for outputting advertisement information specified by said additional information, by simultaneously inputting additional information added to the card sent to said addressee and additional information added to the card sent to said sending client.

20. A computer readable recording medium recorded with an advertisement information providing program according to claim 15, wherein there is further provided;
a second advertisement information output function for adding advertisement identification information for identifying non-visual advertisement information to said card, and outputting non-visual advertisement information specified by said advertisement identification information, based on the added advertisement identification information.
